(19) United States
(12) Patent Application Publication
(10) Pub. No.: US 2005/0121935 A1
(43) Pub. Date: Jun. 9, 2005

(54) Stereophonic fairing accessory

(76) Inventor: Kevin Renee Bell, Decatur, IL (US)

Correspondence Address: PGI, P.O. Box 535, Decatur, IL, 62525, US

(21) Appl. No.: 10/729,489

(22) Filed: Dec. 5, 2003

(51) Int. Cl. B62J 17/00

(52) U.S. Cl. 296/78.1

(57) ABSTRACT

A stereophonic fairing accessory is provided for mounting to handlebars of bicycles and like vehicles. A fairing body with windshield engages and partially covers an elongated component frame for containing stereo componentry. Audio player is integrated into inner fairing body door, alternatively audio source is a joggers type portable player. Options include headlight, tail light, horn/theft alarm and a handlebar mounted joystick thumb remote for easy control of audio functions. Electrical components receives power from a selectively mounted DC (Direct Current) source. Speakers mount thru component frame's two rearwardly forward tilted speaker panels. The component frame has two rearwardly protruding side angle adjust panels, having angled slots, for fairing and handlebar angle adjustment by means of two L-brackets with clamping mechanisims that engage handlebar's two upwardly diverging tubes, I-bracket(s) with clamping mechanisim(s) secures bottom of fairing to handlebar's lower mount portion.

### BACKGROUND OF THE INVENTION

The field of the Invention relates generally to audio accessories which are adapted to be mounted to vehicles with handlebars, like bicycles.

Prior patented bicycle audio systems have not attempted to produce a sound quality that today's sophisticated consumers have come to expect. Previous bicycle audio systems especially, have not had “bass ports”. Today many modern stereo systems have bass ports, these ports allows the release of deep resonance sound waves from the system's speaker enclosure—thus satisfying today's bass hungry audience.

The only two patents (at time of applying for this patent) that were found comparable to stereophonic fairing's capabilities or functions, regarding mountable bicycle audio accessories, were U.S. Pat. No. 4,754,901 to Villanueva, et al., displaying a main body for carrying audio equipment, a pair of speakers permanently mounted to the main body, and U.S. Pat. No. 5,222,752 to Hewitt displaying a fairing and utility assembly: Featuring a complete car audio source (amp and audio player combined into one unit) and rear storage and battery assembly.

Neither offered bass ports or a means of enhancing bass output, nor have they included a means of adjusting the angle of mounted accessory, thus no high-rise handlebar mounting adjustments are claimed, which also denotes no individual choice of accessory's mounting style, or “look” is possible. The stereophonic fairing accessory provides for these type of adjustments, and more so the invention provides a means thru a few alterations, the ability to utilize it's integrated audio configuration, or alternatively embody the use of a self contained portable audio source configuration.

The stereophonic fairing accessory invention allows for another caveat, not previously claimed. The utilization of either an on-board power source, or an externally mounted power source.

Finally: No bicycle audio accessory patents found claimed the control of audio source functions with a remote, more so, the unique intuitive thumb remote claimed for this stereophonic fairing accessory invention.

### SUMMARY OF THE INVENTION

The goal of creating stereophonic fairing accessory was to invent a mountable bicycle and like vehicle audio system, with sound performance rivaling and surpassing the best portable stereo “boom box” system. A bicycle and like vehicle audio system on par with small premium home shelf systems. Consumers should not have to “settle” for lessor sound quality when they leave their automobiles at home.

A fairing body that would mute any weight gains that the stereophonic fairing accessory would add to bicycle. In fact at speeds even with the added weight riders performance would best the performance of a rider without the added fairing on level and downhill terrain.

The current invention provides a stereo fairing with windshield, the windshield provides a degree of air deflection and allows the cyclist a greater view of the road directly in front of the vehicle, as it extends just above the inner fairing body's component frame door. The fairing mounts to the high-rise handlebars of a bicycle and like vehicles.

The stereophonic fairing accessory has two main components, fairing body and component frame—that when combined give speakers an enclosure and close ability of inner component frame—thus forming the whole fairing.

Angle slot tilt adjustment, means cyclist can have their high-rise style handlebars at riders most comfortable angle without altering the Stereophonic fairing accessory's aerodynamic performance (or merely to give fairing a personal style on bicycle). Handlebars lower neck mount portion become central axis of adjustment, accomplished by I-brackets and adjoining clamps which tighten at the handlebar lower mount area, angling of fairing is achieved via angled slots located thru component frames rearwardly protruding angle adjust panels—centrally located above I-bracket's clamp center of rotation—L-brackets tighten at each side thru angled slots in component frame adjust panels and to upwardly extending handlebar tubes. L-bracket's adjoining clamps fix the assembly rigidly to handlebars. L-brackets are slotted for varied handlebar width adjustment.

The clamps for L and I brackets will have inner rubber grips to prevent handlebar scratching and absorb minor vibrations and reduce shock to amp and like componentry.

An alternative audio source configuration is provided: instead of the standad integrated audio source, an audio configuraton is claimed allowing fairing to utilize a self contained portable joggers type of stereo source by means of a Y-cable connection from headphone jack of portable player to amp, amplifying players audio headphone signal.

Design incorporates bass resonance sub-space enhancement, of percieved sound output, achieved by nose wells and bass wave deflection under bass resonance panels, the fairng's roound shape creates a corner at the inner nose, this corner produces a “sub-space” this sub-space acts as a resonance well—sound reverberations creates a high bass wave which channels out rearwardly directed bass ports. True stereo seperation is achieved by body of compnentry frame and a center panel divider at fairing body's inner nose, thus fully seperating left and right stereo sound output.

Accessory is configureabe to receive DC electrical power from either on-board power or the mounting of a DC external power source, either will supply power to all electrical devices.

Stereophonic fairing accesssory as embodied, is not claimed to be water proof, as such it could include a fitted UV and thermal protective plastic cover with elastic rim for tight fit (not claimed or shown), that bears the manufacturers logo. At the manufacturers descretion a weather proof model could be made, utilizing the same general embodiment of fairing's main design, but rubber and foam liners are incorportated with fairing body and door(s)—also instead of the speakers mounted as is, a thin lite film intergrated with speakers grill could filtrate water droplets away from speakers or the speaker cone, woofer and tweeter could be designed as such to be water proof, this waterproof version could be called a “SPORT” or “BEACH” mode. Water proofing does not change inventions primary embodiment and is within related manufacturers technological field of the art.

Consequently the Stereophonic fairing accessory provides not only the enjoyment of music—but has adjustable angle mount positioning for consistent maximum aerodynamic performance, offsetting the added weight of fairing, when cycling to speed, giving the cyclist lessor air resistance and greater speed potential maximums. Exercise and fun are made symbiotic. And it looks kool!

Two methods of manufacture are observed below;
1. “Mass Production”: Stereophonic fairing accessory is ideally mass produced, by manufacturer of like accessories. Manufacturer produces fairing shell by blow molding/vacuum bagging/injection molding or cast light metal forming. Manufacturer produces component frame as one piece, or combined injection molded individual parts. It would be ideal to produce component frame and L & I brackets of cast polished aluminum, because aluminum is a light and rust proof metal. I-brackets may also be molded in plastic as part of component frame, even I-bracket clamp mechanisim can be molded as part of frame. This would save tooling costs, said clamps for L-brackets are also preferably injection molded. Becuse the weight of a durable plastic-like ABS multiplys rapidly, it should be observed that component frame has large holes to reduce weight and allow air/sound flow—these holes will also reduce the volume of casting material required—thus also reducing cost per unit. Manufacturer mounts all electrical/audio componentry. Entire stereophoinic fairing accessory is sold pre-assembled.

2. “Master Kit”: Stereophonic fairing accessory is produced in a model style kit, by manufacturer. Much like “Mass Production” above except major portions, parts and panels are left on the injection molding tree when possible—giving the purchaser the joy of doing it themselves and equally important saving the manufacturer thousands, to potential millions & billions of dollars in production assembly costs. Actual fabrication is similar to above except purchaser will assemble major components and panels by snap, snap/glue and or fasteners etc. Only electrical components will be as complete in wiring and connecton as possible to afford purchaser as safe and easy an assembly as possible.

### BRIEF DESCRIPTION OF THE DRAWINGS

Other objects and caveats of the invention will become mo obvious from the following description and accompanying drawings.

FIG. 1 is a front view of the stereophonic fairng accessory;

FIG. 2 is a side view of the mounted stereophonic fairng accessory;

FIG. 3 is a back (rider) view of stereophonic fairng accessory;

FIG. 4 is a back (rider) view of an alternative embodiment of stereophonic fairng accessory;

FIG. 5 is a perspective view of portable audio media inserting into stereophonic fairng accessory;

FIG. 6 is a perspective view of a battery cell inserting into stereophonic fairng accessory;

FIG. 7 is a perspective view of an alternative embodiment of stereophonic fairng accessory revealing a portable player as audio source;

FIG. 8 is a perspective view of a battery cell inserting into an alternative embodiment of stereophonic fairng accessory;

FIG. 9 is a partial detailed view of integrated media door;

FIG. 10 is a partial exploded, perspective view of brackets and clamps detail;

FIG. 11 is a perspective view of invention mounted to handlebars;

FIG. 12 is a perspective view of invention as depicted in 11 with handlebars in an alternative angle position;

FIG. 13 is a back (rider) view of invention mounted to narrow “SPORTSTER” style high-rise handlebars;

FIG. 14 is a back (rider) view of invention mounted to wider “APE HANGER” style high-rise handlebars;

FIG. 15 is an exploded perspective, back view of stereophonic fairing accessory's alternative embodiment;

FIG. 16 is an exploded perspective, front view of stereophonic fairing accessory's alternative embodiment;

FIG. 17 is a cross sectional, side view of standard and alternative embodiments of invention's component frame's inner details;

FIG. 18 is cross sectional, side view of stereophonic fairing's body, bass enhancement details;

FIG. 19 is cross sectional, top view of stereophonic fairing's body, bass enhancement details;

FIG. 20 is a perspective view of stereophonic fairing accessory and options, mounted to a partial bicycle;

FIG. 21 is a perspective, partially exploded view of intuitive thumb remote;

FIG. 22 is a perspective, exploded view of intuitive thumb remote mounting to a partial handlebar;

FIG. 23 is a perspective view of intuitive thumb remote mounted to a partial handlebar;

FIG. 24 is a close up layout of intuitive thumb remote's head vector function label;

FIG. 24 is a side view of intuitive thumb remote;

FIG. 26 is a side view of intuitive thumb remote's head in an alternative “volume up” position;

### DETAILED DESCRIPTION OF THE PREFERRED EMBODIMENTS

First it should be made clear that references 1 and 2 in any of the FIGS shall mean; 1 to mean the standard audio source embodiment of invention; and 2 to mean the alternative audio source embodiment of the invention. Both in all cases shall be powered, entail bass enhancement and shall mount, angle adjust, fit widths to handlebars 109 by the same means in either embodiment. Using FIGS. 11-14 for example, applies to both embodiments of invention.

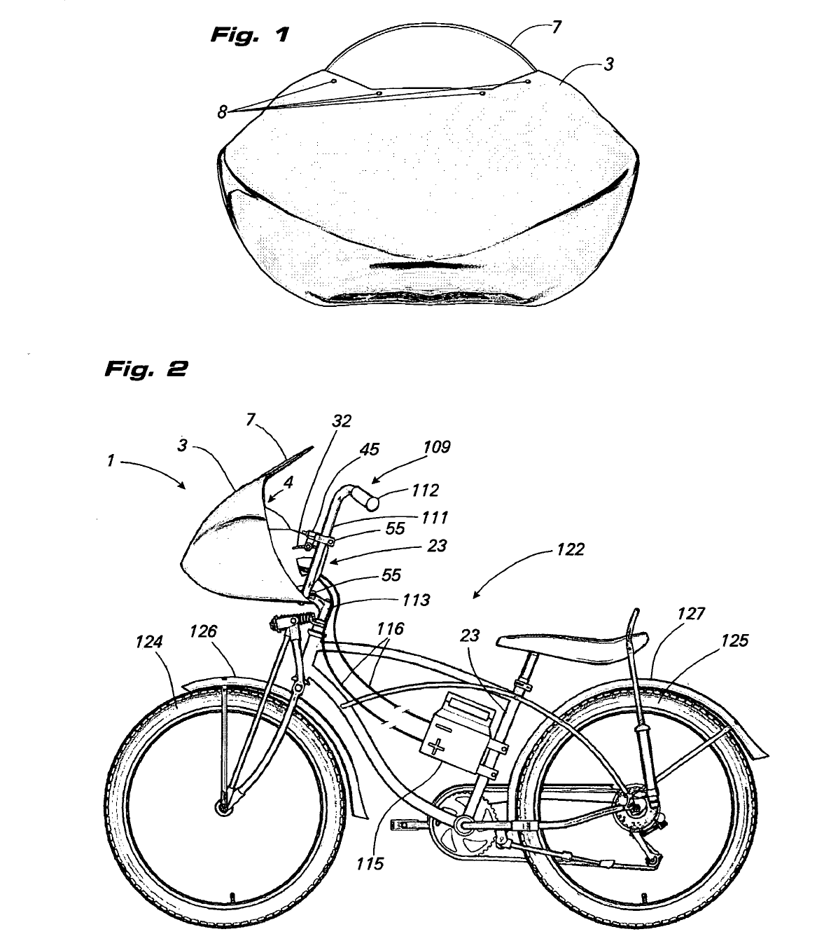

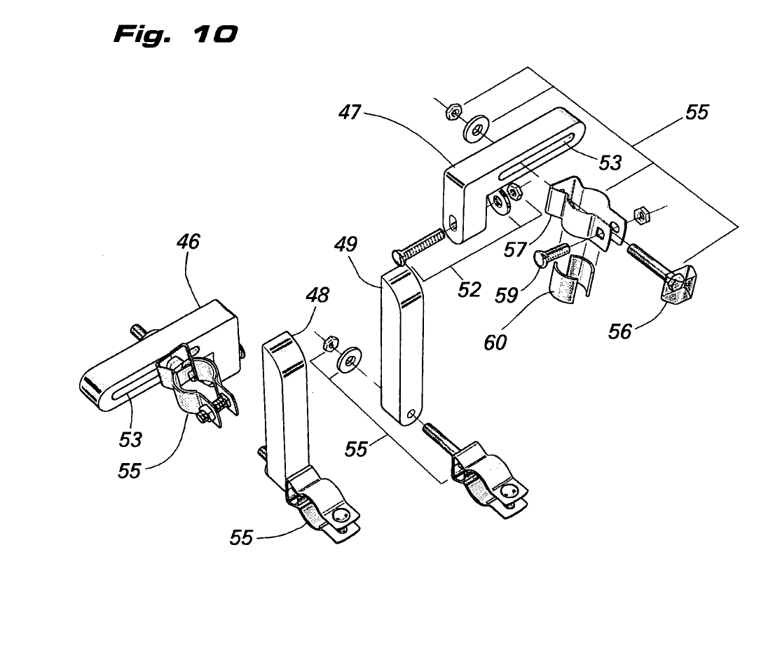

As depicted in FIGS. 1 thru 26, the invention relates to an audio accessory created to mount vehicles with high-rise handlebars, like bicycles. The invention is ideally constructed of an injection molded plastic and or cast and formed aluminum alloys, Windshield 7 is perferably die cut from scooter grade, tranlucent plastic. Observing FIGS. 2-4 and 10-14 it will become apparent as to the premise by which the stereophonic fairing accessroy 1 and 2 mounts to bicycle 122. A better understanding is made by looking first at FIG. 2 and then 10-14, stereophonic fairing accessory 1 and 2, mounts to handlebars 109 by means of left and right L-brackets 46, 47, that fasten to component frame 23, and it's rearwardly protruding side panels 30 and 31 angled slots 32, by means of fastners 52 shown in FIG. 10 and I-brackets 48, 49 shown in FIGS. 3-4 and 10-14, with adjoining conduit clamps 55, that clamps and tightens by fastners 59 shown in FIG. 10, to handlebrs 109, extension tubes 111 and handlebar's lower mount portion 110 shown in FIGS. 11-14, 17.

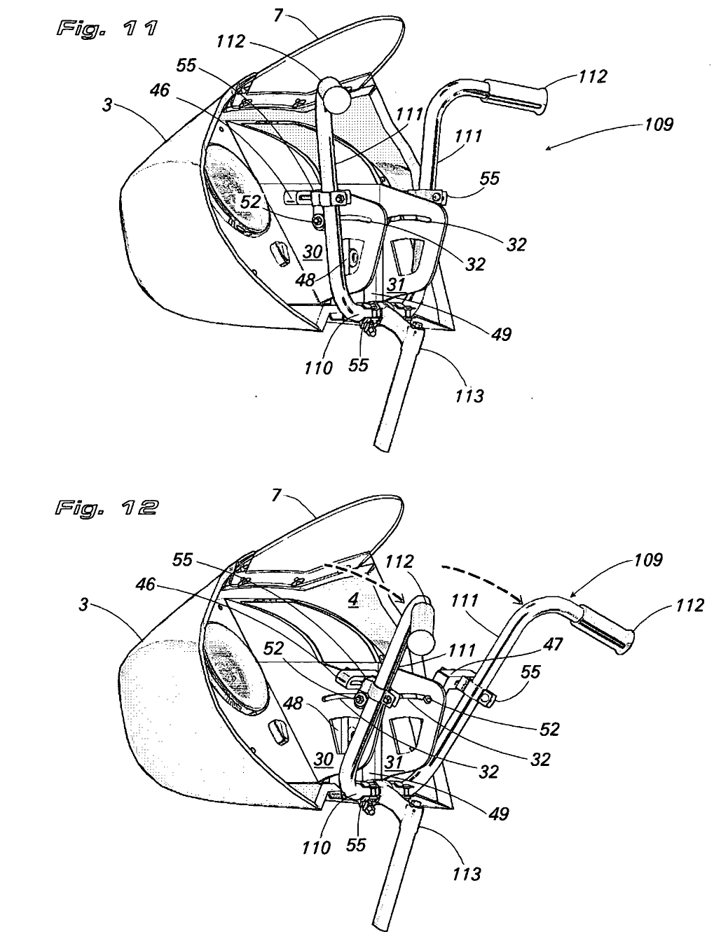

Angle adjustment is shown in FIGS. 11 and 12, in FIG. 11 shows handlebars 109 fully verticle, FIG. 12 shows handlebars 109 in an alternative angled position. Notice: component frame 23 rearwardly protruding left 30 and right 31 side panels, has angled slots 32, that are centrally located above I-bracket's 48, 49 adjoining conduit clamps 55 that are clamped to handlebars 109, lower mount portion 110, allowing high-rise extension tubes 111 to be tilt adjusted by left 46 and right 47 L-brackets and their adjoining conduit clamps 55, bringing handgrips 113 closer to vehicle operator.

Varied style high-rise handlebars 109 width adjust mounting is shown in FIGS. 13 and 14. In FIG. 13 handlebars 109 is a “SPORTSTER” style of high-rise handlebar, and in FIG. 14 handlebars 109 is a wider “APE HANGER” style of high-rise handlebar. Notice that in FIG. 13. L-brackett's left 46 and right 47 width adjust slots 53 as shown closely in FIG. 10, allows adjoining conduit clamp 55, to mount to the further apart extensiion tubes 111, of wider “APE HANGER” handlebars 109. Conduit clamp 55 detail in FIG. 10 shows the resin encapsulated “potted” mount bolt 56 of conduit clamp 55 that matches and seats at clamp base 57, clamp grips 60 will be affixed by scratching inner clamp 55 (smooth inner clamp 55 may detriment affixing grips 60), glue or heat will bond the grips 60 that prevent handlebar 109 scratching when mounting invention and reduce minor vibrations to amp 85 and it related components.

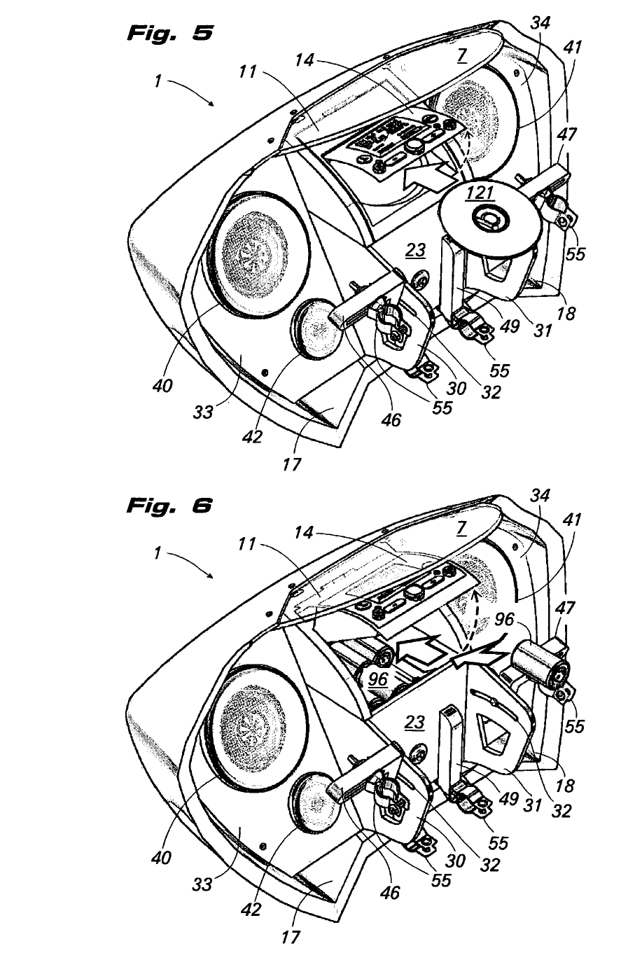

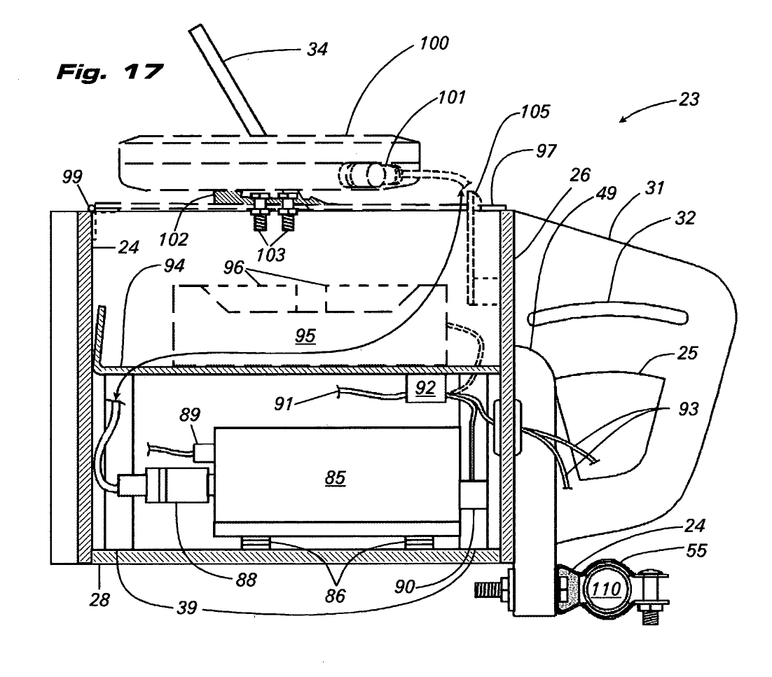

The standard integrated audio embodiment of invention as shown in FIGS. 3, 5, 6 and 9, entails the incorporation of an integrated media door 14, that is hinged to the component frame 23 door 11, that is hinged to inner fairing body 4, just below windshield 7. In FIG. 5 it is shown that by opening 14 allows the insertion of portable pre-recorded media 121, Turning to FIG. 6 opening component frame door 11, opens 14 also which must be closed so that 11 may open adequetly to allow access to component frame 23, second level 94, as seen in FIG. 17, that is a small glove compartment and configuralbe for in-fairing power: alternatively in FIG. 6 allows the installation of battery holders 95, and required DC (direct current) power cell(s) 96, shown inserting into holders 95. Conversly a single large cell (not shown) may also be mounted to 94.

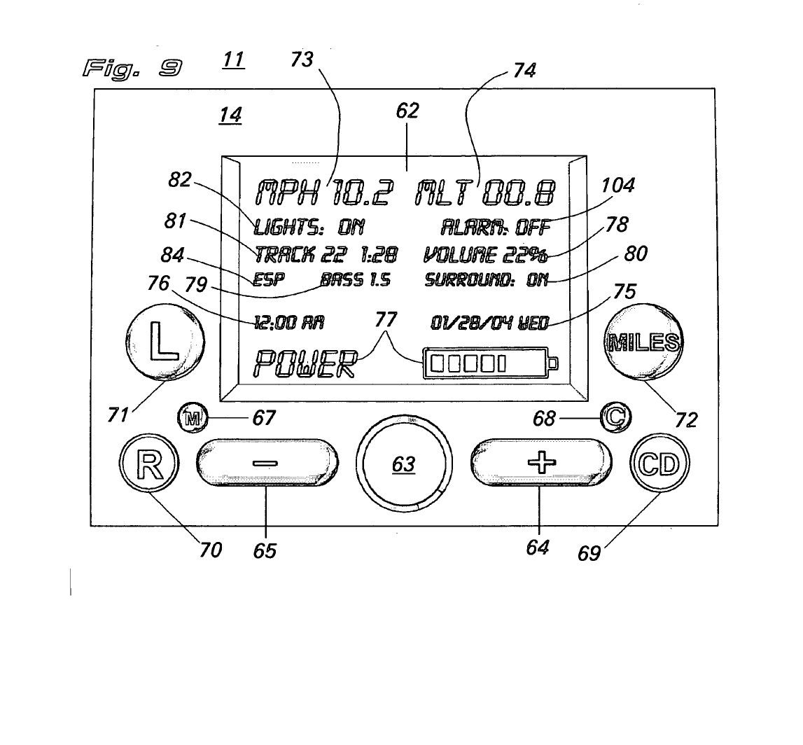

The standard integrated audio embodiment of invention as shown in FIGS. 3, 5, 6 and 9, entails the incorporation of an integrated media door 14, the door's controls and digital display 62, are elaborated in FIG. 9, illustrating it's various indicators are: miles per hour 73, miles traveled 74, calendar 75, time 76, power 77, volume Iwvel 78, base level 79, surround 80, track/station 81, lights 82 and alarm state 104. The control buttons of the integrated media door 14, are: volume on/off knob 63, forward track/station etc. 64, backward track/station etc. 65, mode button 67 ((selects base, esp, surround and alarm) the selection made is adjusted with the volume knob 63 and or forward 64, backwrd 65 buttons), clock/calander button 68, cd player on/off 69, radio-fm/am on/off, lights on/off 71, miles per hour/miles traveled 72. Finally regarding the integrated media door; an analogy to comprehend it's creation is simply the taking of a current multi-function, portable, self contained joggers stereo and placing the entire unit on a hinge, thus clearly the manufacturing technology required, is well within the field of the art.

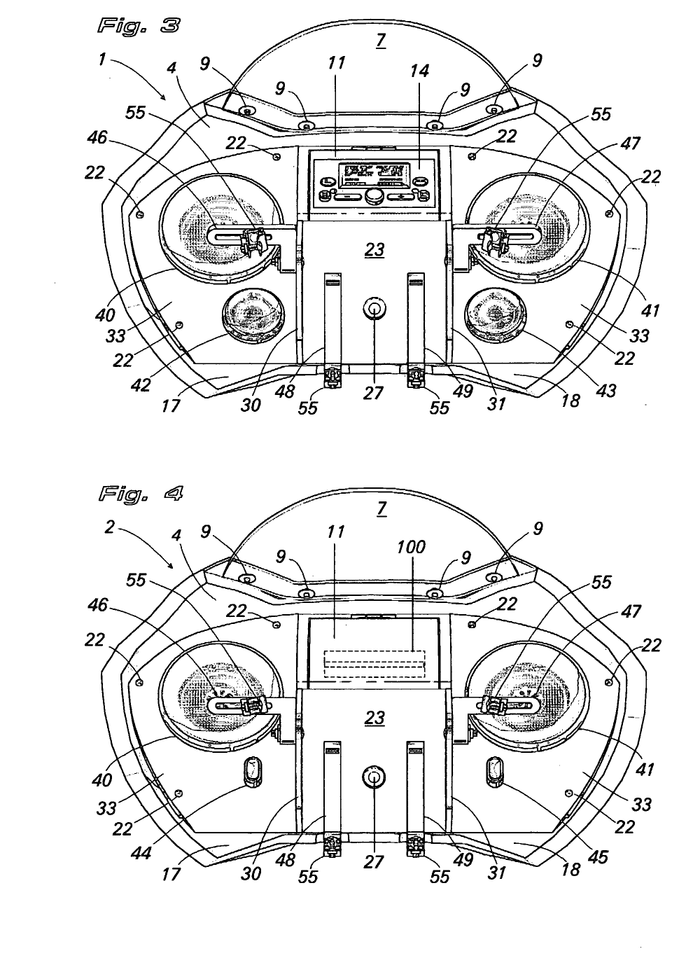

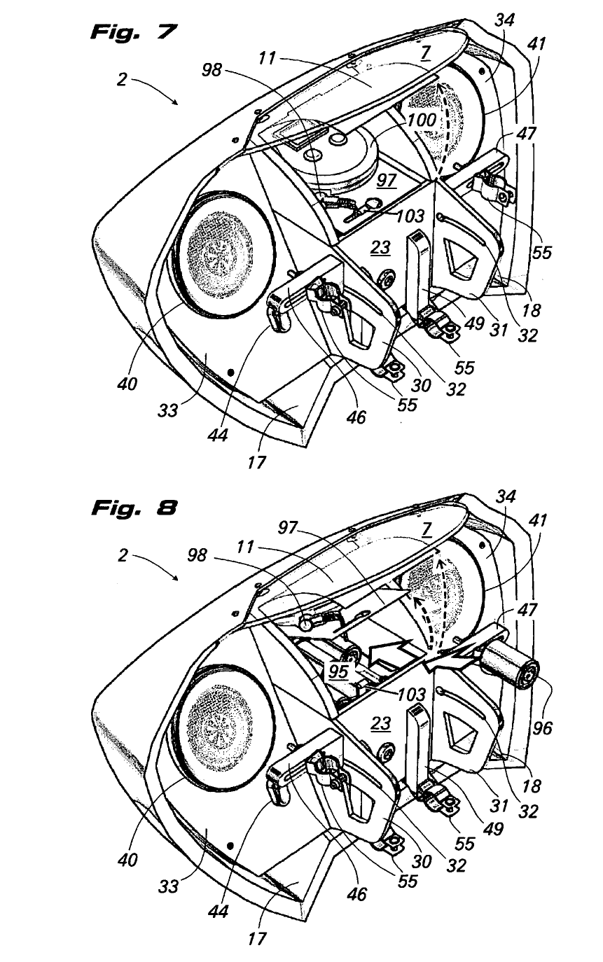

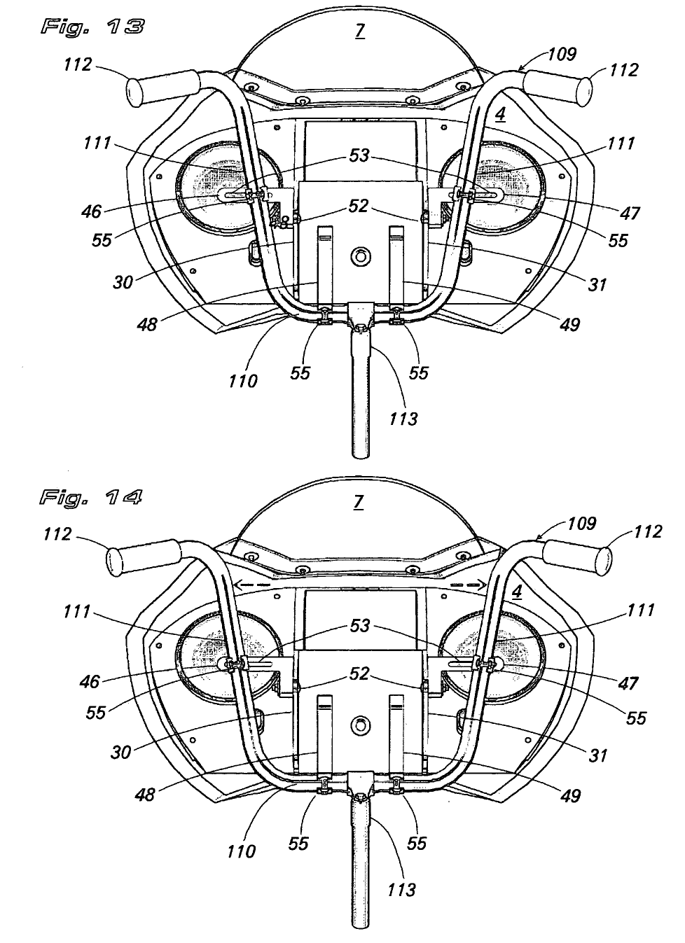

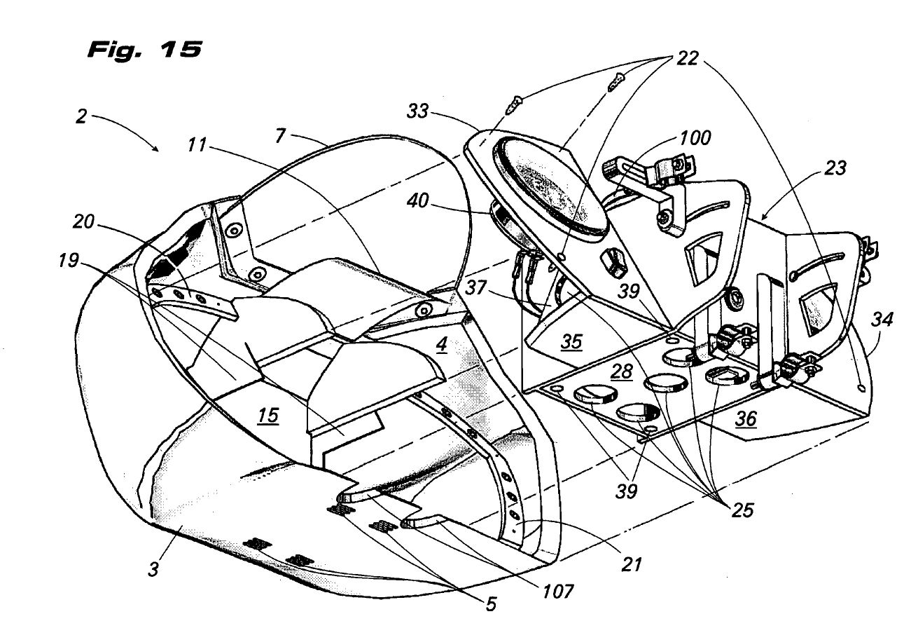

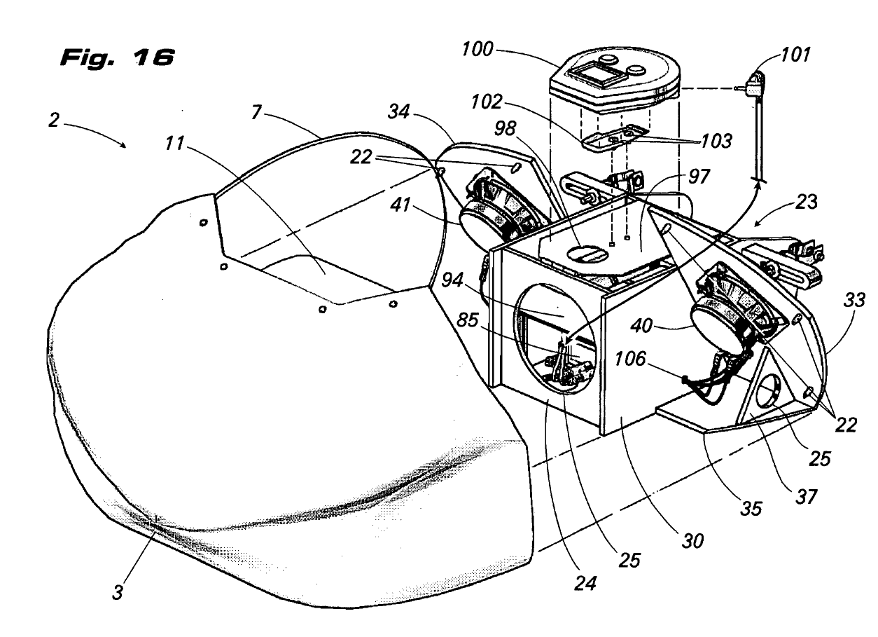

The alternative portable self contained audio embodiment of invention 2 as detailed in FIGS. 4, 7-9 and 15-17. Notice in FIG. 4 component frame 23, door 11 has no control buttons etc. Opening door 11, grants access to portable player 100, that is mounted to a third hinged level 97 shown closely in FIG. 17, player 100 sends audio signals to amp 85 shown in FIG. 17, by way of a headphone plug and cord 101 with phono plugs 88. In FIGS. 16 and 17 is shown how player 100 mounts and is removed from hinged level 97, player 100 belt clip 102, fastens to hinged level 97, by fastners 103, player 100 is removed from hinged level 97, by pushing lock hook 105 this allows lwvel to be lifted open by it's hing 99, then finger(s) can reach thru large removeal access hole 98 shown in FIG. 15, from bottom of hinged level 97 to un-clasp player 100, from fastened belt clip 102.

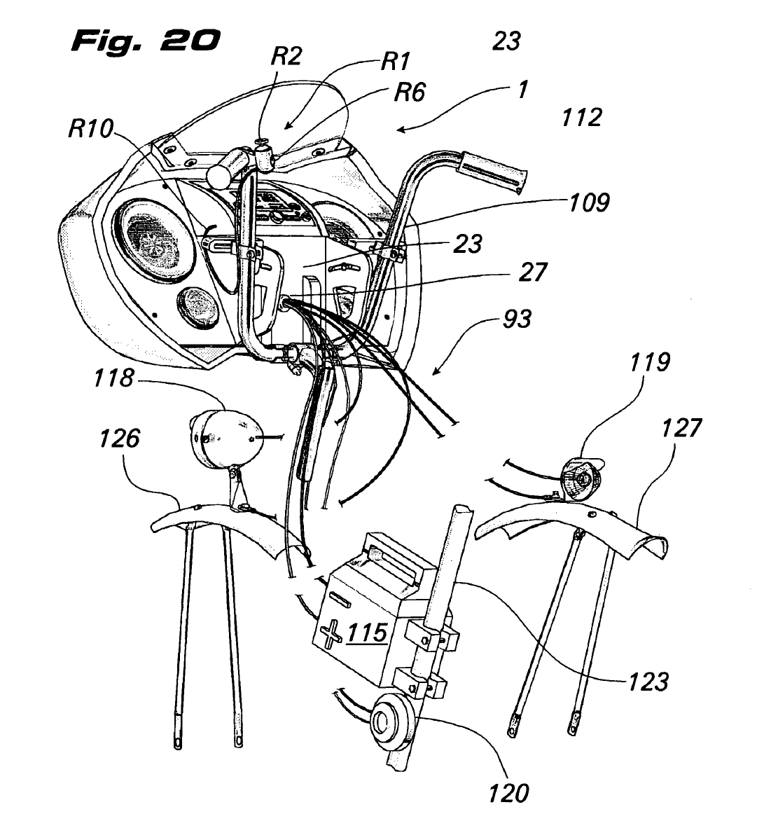

Power is supplied to amp 85 shown in FIG. 17 and optional devices shown in FIG. 20; head light 118 mounted to front fender 126, and tail light mounted to rear fender 127 and horn/alarm siren 120 (refer to FIGS. 2 and 20 for mounting locations) by one of two means: in-fairng battery holders 95 and required cells 96 shown in FIG. 17, alternatively from a typical electric bicycle 122 battery & mount kit 115 shown in FIGS. 2, 20 mounted to frame seatpost tube 123.

By no means all inclusive: FIG. 17 shows a basic means of electrical power and audio signal distribution. Notice: all ghosted parts are alternative embodiments—selectively embodied when applicable, wires 93 lead to external battery 115 and or optional devices shown in FIGS. 2, 20, wires 93 connect to barrier strip(s) 92 that has multi terminal places which centrally distributes power, shown FIG. 17 is the removeable level 94 which is held and monted a distance from amp 85 atop 4 mount dowels 39 shown mounted on this level is the alternative in-fairing power battery holder(s) 95 and required cells 96 it's wires are shown connected to barrier strip(s) 92, see that wires from 92 lead to amp 85 power terminal 90 providing power to amp, wire 91, Iwads to switches of integrated control door 14 shown in FIG. 9, or alternative embodiment 2 light switch 44 and amp power switch 45 shown in FIG. 4 to turn on/off selected device. Speakers receive boosted audio signals from amp 85 speaker terminal 89 wires. Amp 85 is perferably supplied with rubber shocks 86 (grommets or O-rings) to protect amp from rough terrain riding. Amp 85 shown in use for simplicity is a mini car amp, but at manufacturer's descretion in place of this self contained amp 85 will likely be typical portable stereo type circuitry and circuit boards, barrier strips 92 will likely be replaced with a far more sophistcated electrical terminal inputs/outputs with external jacks (not shown) on component frame 23 that devices can plug into (not shown), all of these implied upgrades are within the related manufacturers technological field of the art.

A method of mounting windshield 7, to invention is shown in FIGS. 1, 3 windshield 7 mounts to inner body 4, by fastners 8, and is supported to inner fairing body 4 by large washers 9.

Assembling the main parts of invention as shown in FIG. 15 the component frame 23 attaches to inner fairing 4 left and right mount framer 20, 21 by component frame 23 and its left and right speaker panels 33, 34 mate with the mount framers 20, 21, then fastners 22 tightens the assembly. Observe vents 5 at bottom of outer fairing 3 match location of holes 25 in component frame 23 bottom amp level 28 so that when unit is assembled air flow circulates thru bottom of outer fairiing 3 and holes 25, providing required heat reduction to amp 85 shown in FIG. 17 cooling affect is thus increased as cyclist riding speeds increase.

Stereophonic sound seperatiion method is shown in FIGS. 15, 16 and 19, the inner fairing 4 has a bulkhead panel 15 that mates with component frame 23 front panel 24 shown in FIG. 15, lips 19 seals sound in by fitting snugly onto component frame 23, side panels 30, 31, FIG. 19 shows a nose divider 15, at front of inner fairing 4, thus component frame 23 body and nose divider 15 fully seperates inner fairig body, 4 sound.

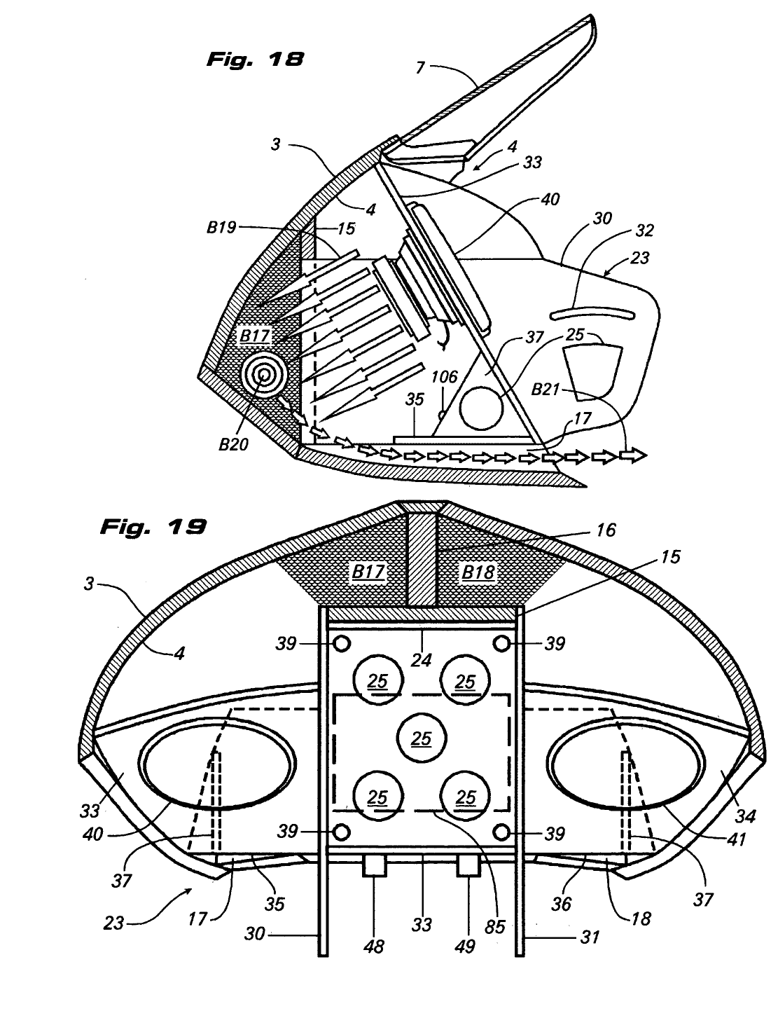

Base resonance enhancement is shown in FIGS. 18, 19, sound waves B19 from rear of speaker 40 is directed to front of component frame 23, where there is corner pockets called a resonance wells B17, B18 for left and right speakers 30, 31, the resonance wells B17, B18 is where bass enhancement occurs, then enhanced sound reverberations B20 base waves B21 flows under left and right base resonance dividers 35, 36 shown in FIG. 15 and out left and right base ports 17, 18 shown also in FIGS. 3-8.

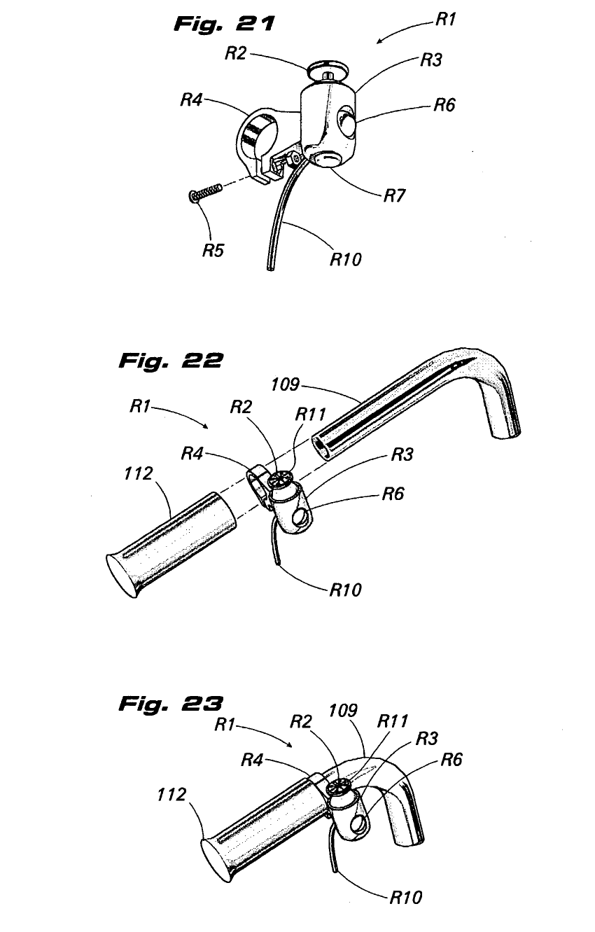

Standard embodiment 1 of invention's basic audio and accessory functions are alternatively controlled by an optional intuitive thumb remote R1 shown in FIGS. 20-26, remote R1 has a main body R3, multi pivotal thumb stick R2 to control audio functions, a horn button R6 at back of body R3, a light button R7 at bottom of body R3, affixed to main body R3 is a tube clamp R4 (notice that tube clamp R3 is very narrow, perferrably about 0.375″ or less, allowing space for mirriors, hand brakes etc. on handlebars), clamp R3 tightens over tube by means of fastner R5 shown in FIG. 21, handgrip 113, is rempved from handlebar 109 to mount remote R1 to handlebar 109.

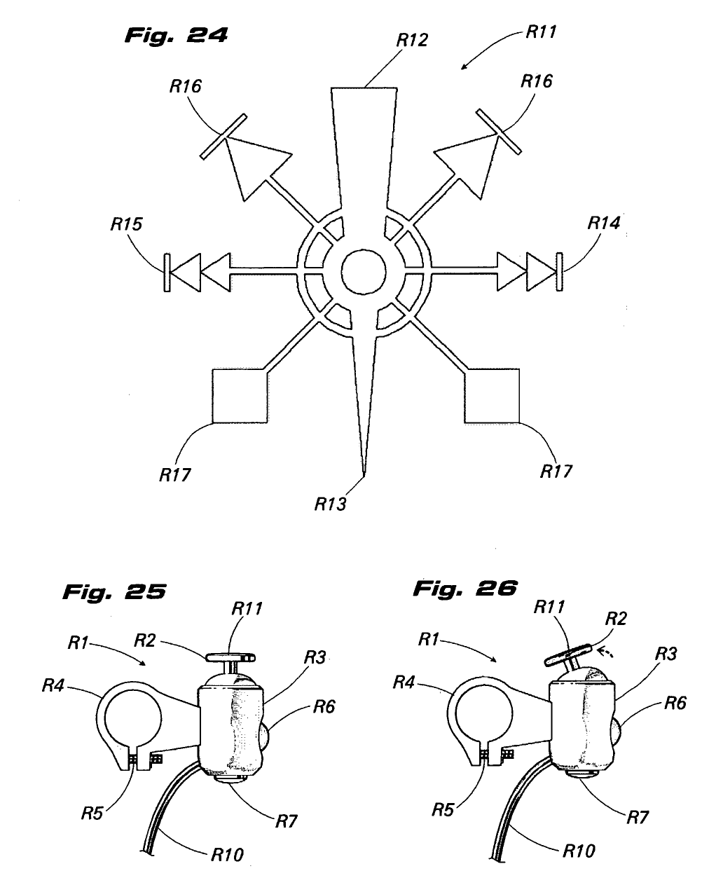

Control of intuitive thumb remote R1 audio functions is achieved by pushing thumb joystick head R2 in one of eight directional vectors (like todays video game system joy sticks), the indication function label R11 detailed in FIG. 24 shows eight vector directoion funtions that are: push stick south=volume down R13, push stick north=volume up R12(FIG. 26 shows an example of thumb stick R2 in a vollume up position), push stick northeast and northwest=on-play/pause, push stick east=track/station forward R14, push stick west=track/station backward R15, push stick southeast and southwest=stop/off R17—pushing once enables the first function/pushing twice (within 3 seconds) enables the second function (this does not apply to track/station which is selected by use of the integrated media door 14, choosing radio button 70 or cd button 69 shown in FIG. 9. Without flinching, vehicle operator by means of the intuitive thumb remote R1 can keep his/hers eyes on the road, while safely turning up the volume or searching for a desired track/station.

1. A stereophonic fairing accessory for mounting to the upwardly extending high-rise styled handlebars of bicycles and like vehicles, comprising:
an integrated stereo audio player, that selectively: plays pre-recorded media, incorporates the reception of frequency and amplitude modulated musical programing, incorporates bicycle computer type functions and has required on/off means thereoff;
electrical options: head light, tail light, horn/theft alarm;
electrical componentry receive power from a selectively mounted and positioned DC (Direct Current) electric source;
a fairing body with windshield,
windshield mounts by selective means,
windshield is formed of a translucent simi flexible material;
fairing body is formed of a minimally flexable, durable, material;
an optional handlebar mounted, custom intuitive thumb remote,
said remote controls audio functions by pushing head of joystick in one of eight directional vectors,
said remote selectively incorporates on/off horn and light buttons,
remote is formed of a material like fairing body;
a component frame with a bottom fixed level, a second removeable level, that all run horizontal, the bottom fixed level for amp and it's required circuitry, the second removealbe level for small parcels—it is also selectively configured to mount DC power cell(s),
component frame and it's levels are formed of a rigid, durable material;
said component frame has two symetrical rearwardly facing, forward tilted speaker panels for mounting speakers,
said frame has two rearwardly protruding side angle adjust panels, the opposing side panels have angled slots for fairng or handlebar angle adjustment, acheived by two fastenable adjustable slotted L-brackets, slot in L-bracket allows for varied high-rise styled handlebar width mounting, L-brackets fasten to opposing angled slotted component frame's angle adjust panels,
said removeable adjustable L-brackets and component frame's permanently affixed non adjustable I-bracket(s) both utilize clamping mechanisims of a selective type, L-bracket's ajoined clamping mechanisim clamp to vehicle's upwaredly diverging handlebar extension tubes, I-bracket(s) clamping mechanisim(s) engage said handlebar's lower mount portion.

2. The accessory of claim 1, wherein said component frame has two rearwardly angle adjust panel protrusions, the outer distance between the two panels are of a width to fit between most high-rise style handlebars having opposed upwardly diverging extension tubes.

3. The accessory of claim 1, wherein I-bracket's ajoined clamping mechanisim clamp to handlebar's lower mount portion, lower handlebar becomes the central axis by which the angle of fairing's adjustment is acheived held in place by two I-brackets and ajoining conduit clamps, the I-brackets also act as spacers, allowing the neccessary clearance between component frame and neck clamp area of handlebars.

4. The accessory of claims 2, wherein said clamps fasten to L and I brackets, selectively utilized are conduit clamps, the clamp's bolt that passes thru it's base will have it's head potted—meaning fixing hexagonal bolt's head by means of a molding resin, preferably with fiber reinforcemt, potting allows the base bolt's nut to be tightened while clamp is on handlebar, said length of clamp's potted bolt fastens thru upside down L-bracket's width slot and I-bracket's holes,
said conduit clamp will have shock reducing, thin rubber grip pads, these grips are permanently affixed to inner face of clamp by selective means, grips keep handlebars from being scratched during installation, of stereophonic fairing accessory.

5. The accessory of claims 1, wherein a said optional custom intuitive thumb remote is provided; this remote attaches to handlebar near handgrip by means of a C type clamp affixed to remote body that tightens on bar by means of appropriate fastner(s), said remote's thumb joystick has a flat round head with tiny bumps for a sure thumb grip, this head has an indication function label notating vector direction and audio function.

6. A stereophonic fairing accessory for mounting to the upwardly extending high-rise styled handlebars of bicycles and like vehicles, comprising:
a component frame for the selective mounting of audio componentry, frame mates with the inner body of the fairing's permanently affixed inner mount framers that match the outer perimeter and shape of fairing body from a front and back view,
st bottom of frame's speaker panels are two short bass resonance panels, extending one on each side of the frame's main body, that align with frame's bottom, perpindicularly affixed between speaker panels and bass resonance panels are triangle shaped angle panels that provide structural gusset support to the speaker panels,
said frame's main body has four sides front and back panels and two elongated side panels that extend rearwardly beyond the position of the back panel;
weight reducing, air and sound flow holes are in said fairing's mount framers and component frame's panels wherever it shall not interfere with structural integrity, function and aesthetics of such.

7. The accessory of claim 1, wherein bottom fixed level is for amp mounting, said bottom level has airflow openings that match the general position of openings at bottom of fariing body allowing amp to gain air circulation, amp will selectively mount atop rubber spacers for added physical shock protection.

8. The accessory of claim 7, wherein bottom fixed level is for amp mounting, said amp proveides means for electrical power connection, from amp to power switch which in turn connects to selectively mounted barrier strips, that receive power frem a selectively mounted DC power source.

9. The accessory of claim 8, wheren power is accessable to amp, the circuit of power flow will eb thru said multi terminal barrier strip(s), terminals on the strip(s) will recieve power from a DC electric power source, the barrier strip(s) provide a central connection for all electrical devices, barrier strip(s) are selectively mounted to inner component frame, circui provides electircal source renewing means, via applicalbe device means required thereof.

10. The accessory of claim 1, wherein a removeable second level is provided, means removed for amp and circuitry repair and upgrade, said circuit's electrical DC power comes from availiable stock portable power sources for electric bicycle motor kits—these are adaptable for use with stereophonic fairing accessory.

11. The accesssory of claim 1, wherein an integrated stereo player audio source is provided, player is built into said inner fairing body's door; this built in hinged door is an integrated media door that allows insertion of pre-recorded media and has a digital display showing all unit functions, integrated media door has controls required for every funtion thereoff.

12. The accesssory of claim 11, wherein audio source is integrated into inner fairing body's door; alternatively auido sourece is a portable self contained jogger's type of media player; portable audio source provides audio signal via headphone jack and the use of a Y cable, bearing one headphone plug and two phono jacks for amp left and right stereo connection thus amplifying portable audio source's signal output.

13. The accesssory of claim 12, wherein alternatively audio source is a portable player; in this configuration component frame will have a top hinged level that the player is mounted to by selective means, the player and it's hinged level is closed off by the hinged door at fairing's inner body below windshield.

14. The accessory of claim 13, wherein alternative audio source is a portable player; said component frame's speaker panels shall each bear a switch, one for amp and one for optional lighting on/off control.

15. A stereophonic fairing accessory for mounting to the upwardly extending high-rise styled handlebars of bicycles and like vehicles, comprising:
two major parts, when combined form the complete stereophonic fairing accessory;
fairing body is the first part, having an outer and inner body, inner body has two mount framers, their perimeter matches component frame's speaker panels perimeter,
component frame is the second part, it mates with the fairing body's mount framers,
said first and second part is fixed wih fastners, that go thru both speaker panels and mount framers, this fixes fairing body to component frame, forming a whole, the speaker panels edge and mount framers perimeter define the general forward and rearward profile of fairing;
speakers are mounted to speaker panels, essentially creating an enclosed left amd right speaker box,
said whole creates left and right stereo seperation,
said whole creates corner sub-spaces at nose of inner fairing, that porvides stereophonic bass resonance enhancement at inner fairing's nose.

16. The accessory of claim 15, wherein left and right stereo seperation is achieved; the component frame's body and a nose dividing panel affixed at nose of inner fairng body, divides inner fairing body creating two separate speaker enclosures.

17. The accessory of claim 6, wherein said speakers panels has base resonance panels affixed to bottom, said short bass resonance dividing panel's matches shape of fairing's body, from a top and bottom view, when frame is engaged with inner fairing's side body, bass ports are formed below speaker panels, thus directing inner sound out of rearward facing bass ports.

18. The accessory of claim 15, wherein bass resonance enhancement is claimed, sub-spaces at the inner nose of fairing body, produces temporal resonance wells—here sound reverberations create a high bass wave, which transfers below the speaker panel's lower bass resonance panel and eminates out the fairng's rearwardly facing bass ports.

19. The accessory of claim 1, wherein optional electrical devices are provided: optional headlight mounts selectively to front of vehicle by selective mean; optional tail light selectively mounts to rear of vehicle by selective means; optional horn/theft alarm selectively mounts to vehicle by selective means.

20. The accessory of claim 19, wherein optional theft horn/alarm siren mounts to vehicle, horn/theft alarm is motion sensing device; said optional electrical device's power wires lead to component frame's inner barrier strip(s), which in turn leads to a selectively mounted DC electric power source.
